(19) United States
(12) Patent Application Publication
(10) Pub. No.: US 2015/0134342 A1
(43) Pub. Date: May 14, 2015

(54) Enhancement of Narrowband Audio Signals Using Single Sideband AM Modulation

(71) Applicant: Dialog Semiconductor B.V., 's-Hertogenbosch (NL)

(72) Inventor: Panayiotis Savvopoulos, Rio Patras (GR)

(21) Appl. No.: 14/302,580

(22) Filed: Jun. 12, 2014

(30) Foreign Application Priority Data
Nov. 12, 2013 (EP) 13192576.0

(51) Int. Cl. G10L 19/02

(52) U.S. Cl. CPC G10L 19/02
USPC 704/500

(57) ABSTRACT

The present document relates to the efficient processing of audio signals for enhancing the perceptual quality of the audio signal. An audio processing unit configured to generate an enhanced audio signal from an input audio signal is described. The input audio signal is sampled at a first sampling rate and the enhanced audio signal is sampled at a second sampling rate, wherein the second sampling rate is higher than the first sampling rate. The input audio signal comprises spectral content in a frequency range up to a first frequency and the enhanced audio signal comprises spectral content in a frequency range up to a second frequency, wherein the second frequency is higher than the first frequency. The audio processing unit comprises an upsampling and interpolation unit configured to generate an upsampled audio signal at the second sampling rate from the input audio signal.

### TECHNICAL FIELD

The present document relates to audio processing. In particular, the present document relates to the efficient processing of audio (e.g. voice) signals for enhancing the perceptual quality of the audio signal.

### BACKGROUND

Audio signals are typically sampled at a pre-determined sampling rate (e.g. at 8 kHz). As a result of the pre-determined sampling rate, the audio signal exhibits a limited bandwidth (e.g. 4 kHz). The limited bandwidth may lead to a limited perceptual quality of the sampled audio signal.

The present document addressed the above mentioned technical problem. In particular, the present document describes a method and a corresponding system for enhancing the perceptual quality of a bandwidth limited audio signal.

### SUMMARY

According to an aspect, an audio processing unit configured to generate an enhanced audio signal from an input audio signal. The input audio signal may comprise or may be a voice or speech or music signal. The input audio signal may be sampled at a first sampling rate and the enhanced audio signal may be sampled at a second sampling rate, wherein the second sampling rate is typically higher than the first sampling rate. In particular, the second sampling rate may be two times the first sampling rate. By way of example, the first sampling rate may correspond to 8 kHz and the second sampling rate may correspond to 16 kHz. The input audio signal may comprise spectral content in a frequency range up to a first frequency (e.g. 4 kHz). Typically, the first frequency corresponds to half of the first sampling rate. The enhanced audio signal may be generated such that the enhanced audio signal comprises spectral content in a frequency range up to a second frequency (e.g. 8 kHz). Typically, the second frequency corresponds to half of the second sampling rate. The second frequency is usually higher than the first frequency.

The audio processing unit comprises an upsampling and interpolation unit configured to generate an upsampled audio signal at the second sampling rate from the input audio signal. The upsampling and interpolation unit may comprise an upsampling unit configured to insert one or more zero samples into a sequence of samples of the input audio signal, to provide an intermediate signal. In particular, a (e.g. a single) zero sample may be inserted between all adjacent pairs of samples of the sequence of samples of the input audio signal, in order to double the number of samples (i.e. in order to double the sampling rate). Furthermore, the upsampling and interpolation unit may comprise an interpolation unit configured to filter the intermediate signal to provide the upsampled audio signal. The filter may be a low pass filter configured to remove aliases from the intermediate signal. By way of example, the filter may be a finite impulse response filter (FIR).

The audio processing unit further comprises a modulation unit configured to generate a modulated audio signal from the upsampled audio signal. The modulated audio signal may be generated such that the modulated audio signal comprises spectral content in a frequency range between the first frequency and the second frequency. The spectral content in the frequency range between the first frequency and the second frequency may be derived from the spectral content of the input audio signal (e.g. by performing a frequency shift of some of the spectral content of the input audio signal). The modulated audio signal may be such that it only comprises spectral content in the frequency range between the first frequency and the second frequency (and no spectral content in the frequency range between 0 Hz and the first frequency). In particular, the modulated audio signal may be such that it comprises a copy of the spectral content of the input audio signal within the frequency range of 0 Hz up to the first frequency.

The modulation unit may be configured to perform single sideband amplitude modulation of the upsampled audio signal using a carrier signal which is sampled at a quarter of the second sampling rate. By doing this, the modulated audio signal may be generated at relatively low computational complexity.

As indicated above, the second sampling rate may be double the first sampling rate. In a similar manner, the second frequency may be two times the first frequency. The spectral content of the modulated signal may be derived from the spectral content of the input audio signal in the frequency range between 0 Hz and the first frequency. The spectral content of the input audio signal may be shifted to the frequency range between the first frequency and the second frequency, using the modulation unit. The spectral content of the modulated signal may then be derived based on or may correspond to this shifted spectral content.

In particular, the modulation unit may comprise a COS modulator configured to modulate the upsampled audio signal with a sampled cosine carrier signal, to provide a cosine modulated audio signal. In other words, the COS modulator may be configured to process the upsampled audio signal by utilizing a sampled cosine carrier signal. The generation of the cosine modulated audio signal may be performed within a first branch of the modulation unit (based on a first copy of the upsampled audio signal). The COS modulator may be configured to multiply samples of the upsampled audio signal with corresponding samples of the sampled cosine carrier signal. The cosine carrier signal may be sampled at a quarter of the second sampling rate, i.e. at a quarter of the sampling rate of the upsampled audio signal. In such a case, the samples of the sampled cosine carrier signal only comprise one or more (in particular all) of the following values: 0, −1, +1. Hence, the operations of the COS modulator may be implemented in an efficient manner, as the COS modulator only needs to perform the operations of setting to zero, copying or sign inverting of samples.

The modulation unit may comprise a second branch for generating a sine modulated audio signal (based on a second copy of the upsampled audio signal). In particular, the modulation unit may comprise (within the second branch) a Hilbert transform unit (also referred to as a Hilbert transformer) configured to generate a transformed audio signal from the upsampled audio signal, such that the transformed audio signal comprises spectral content which is phase shifted with respect to the spectral content of the upsampled audio signal. The Hilbert transform unit may be configured to apply a Hilbert transform to the upsampled audio signal. For this purpose, a filter (e.g. a FIR filter) may be applied to the upsampled audio signal.

Furthermore, the modulation unit may comprise a SIN modulator configured to modulate the transformed audio signal with a sampled sine carrier signal, to provide a sine modulated audio signal. The sine carrier signal may be sampled at a quarter of the second sampling rate. In a similar manner to the cosine carrier signal, the samples of the sampled sine carrier signal may only comprise one or more (in particular all) of the following values: 0, −1, +1. Hence, the sine modulation may be performed at relatively low computational complexity.

As such, the SIN modulator and the COS modulator may be configured to generate a sample of a modulated output signal from a sample of an input signal by one or more of the following operations: setting to zero the sample of the input signal; copying the sample of the input signal; and/or sign inverting the sample of the input signal. These operations may be performed at low computational complexity.

The modulation unit may comprise a look-up table which is indicative of the samples of the sampled cosine carrier signal and/or the samples of the sampled sine carrier signal. The SIN modulator and/or the COS modulator may be configured to access the look-up table for generating/retrieving the sine cosine samples which are used by the modulator and thereby generating/retrieving the sine and/or cosine modulated audio signals, respectively. By doing this the computational complexity for generating the modulated audio signal may be reduced.

The modulation unit may comprise a second delay unit configured to delay the cosine modulated audio signal by a pre-determined second delay. Furthermore, the modulation unit may comprise a second combination unit configured to generate the modulated audio signal from the delayed cosine modulated audio signal and from the sine modulated audio signal. As such, the second delay unit ensures that corresponding samples of the cosine modulated audio signal and the sine modulated audio signal are combined to form the modulated audio signal.

The audio processing unit further comprises a delay unit configured to delay the upsampled audio signal by a pre-determined delay, to provide a delayed audio signal. As such, the audio processing unit may comprise a first processing path for generating the modulated audio signal from a copy of the upsampled audio signal, and a second processing path for delaying another copy of the upsampled audio signal. The audio processing unit further comprises a combining unit configured to generate the enhanced audio signal based on the delayed audio signal and based on the modulated audio signal. As indicated above, the enhanced audio signal may comprise spectral content which is a combination of the spectral content of the input audio signal and a shifted version of at least a portion of the spectral content of the input audio signal.

The combining unit may be configured to generate a sample of the enhanced audio signal based on corresponding samples of the delayed audio signal and the modulated audio signal. The pre-determined delay may correspond to a processing delay incurred within the modulation unit, such that the corresponding samples of the delayed audio signal and of the modulated audio signal correspond to the same sample of the upsampled audio signal. Hence, the delay unit may ensure that corresponding pairs of samples from the upsampled audio signal and from the modulated audio signal are combined to form the enhanced audio signal. The audio processing unit may comprise a gain unit configured to modify the power of (e.g. attenuate) the modulated audio signal, in order to provide an attenuated audio signal (i.e. an attenuated version of the modulated audio signal). The gain may be selected based on psychoacoustic considerations (e.g. based on listening tests). The combining unit may be configured to generate the enhanced audio signal based on the delayed audio signal and based on the attenuated audio signal (i.e. based on the attenuated version of the modulated audio signal). By applying a configurable gain to the shifted spectral content, the perceptual quality of the enhanced audio signal may be tuned.

According to a further aspect, a system for enhancing an input audio signal with additional spectral content is described. The system comprises a first audio processing unit comprising any of the features described in the present document. The first audio processing unit may be configured to generate a first enhanced audio signal from the input audio signal. In particular, the first audio processing unit may be configured to generate the first enhanced audio signal, such that it comprises additional spectral content compared to the input audio signal. Furthermore, system comprises a second audio processing unit comprising any of the features described in the present document. The second audio processing unit may be configured to generate a second enhanced audio signal from the first enhanced audio signal. In particular, the second audio processing unit may be configured to generate the second enhanced audio signal, such that it comprises additional spectral content compared to the first enhanced audio signal. As such, the input audio signal may be further enhanced by cascading a plurality of audio processing units.

According to a further aspect, a system for enhancing an input audio signal with additional spectral content, the system comprising a first audio processing unit, configured to generate a first enhanced audio signal from the input audio signal, and a second audio processing unit, configured to generate a second enhanced audio signal from the first enhanced audio signal, wherein said first audio processing unit and said second audio processing unit audio are configured to generate an enhanced audio signal from an input audio signal, wherein the input audio signal is sampled at a first sampling rate; wherein the enhanced audio signal is sampled at a second sampling rate; wherein the second sampling rate is higher than the first sampling rate; wherein the input audio signal comprises spectral content in a frequency range up to a first frequency; wherein the enhanced audio signal comprises spectral content in a frequency range up to a second frequency, wherein the second frequency is higher than the first frequency; wherein the audio processing unit comprises an upsampling and interpolation unit configured to generate an upsampled audio signal at the second sampling rate from the input audio signal, a modulation unit configured to generate a modulated audio signal from the upsampled audio signal, such that the modulated audio signal comprises spectral content in a frequency range between the first frequency and the second frequency, which is derived from the spectral content of the input audio signal, a delay unit configured to delay the upsampled audio signal by a pre-determined delay, to provide a delayed audio signal, and a combining unit configured to generate the enhanced audio signal based on the delayed audio signal and the modulated audio signal.

According to a further aspect, a method for generating an enhanced audio signal from an input audio signal is described. The input audio signal is sampled at a first sampling rate, and the enhanced audio signal is sampled at a second sampling rate, wherein the second sampling rate is higher than the first sampling rate. The input audio signal comprises spectral content in a frequency range up to a first frequency and the enhanced audio signal comprises spectral content in a frequency range up to a second frequency, wherein the second frequency is higher than the first frequency. The method comprises generating an upsampled audio signal at the second sampling rate from the input audio signal. The method proceeds in generating a modulated audio signal from the upsampled audio signal, such that the modulated audio signal comprises spectral content in a frequency range between the first frequency and the second frequency, wherein the spectral content in the frequency range between the first frequency and the second frequency is derived from the spectral content of the input audio signal. Furthermore, the method comprises delaying the upsampled audio signal by a pre-determined delay, to provide a delayed audio signal. The enhanced audio signal is generated based on the delayed audio signal and based on the modulated audio signal.

According to a further aspect, a software program is described. The software program may be adapted for execution on a processor and for performing the method steps outlined in the present document when carried out on the processor.

According to another aspect, a storage medium is described. The storage medium may comprise a software program adapted for execution on a processor and for performing the method steps outlined in the present document when carried out on the processor.

According to a further aspect, a computer program product is described. The computer program may comprise executable instructions for performing the method steps outlined in the present document when executed on a computer.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

### BRIEF DESCRIPTION OF THE DRAWINGS

The invention is explained below in an exemplary manner with reference to the accompanying drawings, wherein

FIG. 1a illustrates a block diagram of an example audio processing unit configured to enhance an input audio signal;

FIG. 1b shows a block diagram of an example modulation unit;

FIG. 1c shows a block diagram of another example modulation unit;

FIG. 2 illustrates an example cascading of audio processing units; and

FIG. 3 shows a flow chart of an example method for enhancing an input audio signal.

### DESCRIPTION

As outlined above, the present document is directed at enhancing the perceived quality of an input audio signal. In particular, it is proposed to expand the bandwidth of a bandwidth-limited input audio signal, in order to improve the perceptual quality of the audio signal. The present document describes a method and a corresponding audio processing unit which allow improving the perceptual quality of the audio signal, at relatively low computational complexity.

The proposed method may make use of an amplitude modulation technique referred to as SSB (Single Side-Band) amplitude modulation (AM), in order to enhance the spectral content of a narrowband input audio signal. By way of example, the input audio signal may be sampled at a first sampling rate of 8 kHz. It is an aim of the aforementioned method to generate an enhanced audio signal with an increased second sampling rate (e.g. a 16 kHz sampling frequency). The enhanced audio signal comprises artificially added spectral content in the added range of frequencies (e.g. in the range of [4 kHz, 8 kHz]). By doing this, the hearing experience can be improved. The additional spectral information can be derived from the original spectrum of the input audio signal by shifting the original spectrum in frequency according to the carrier frequency of the modulator.

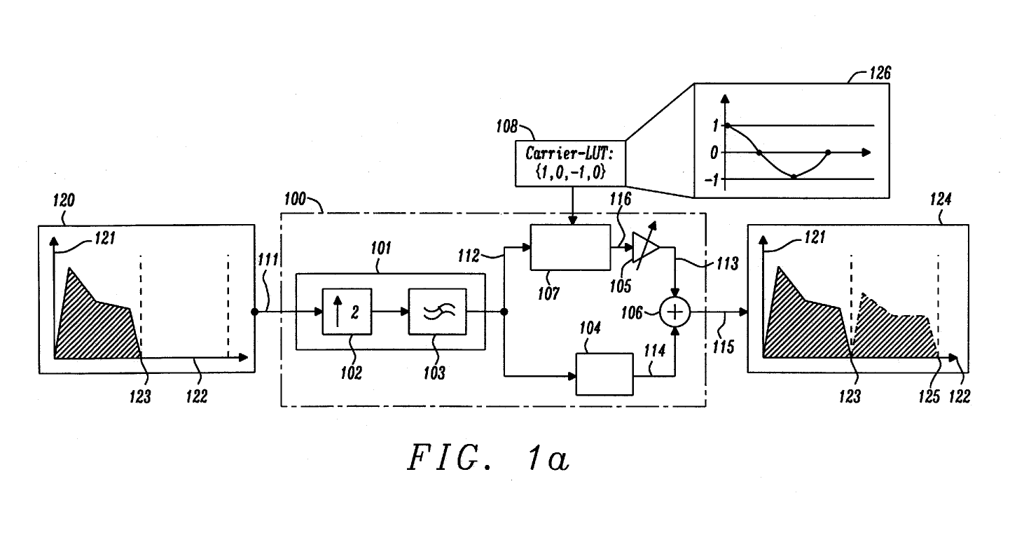

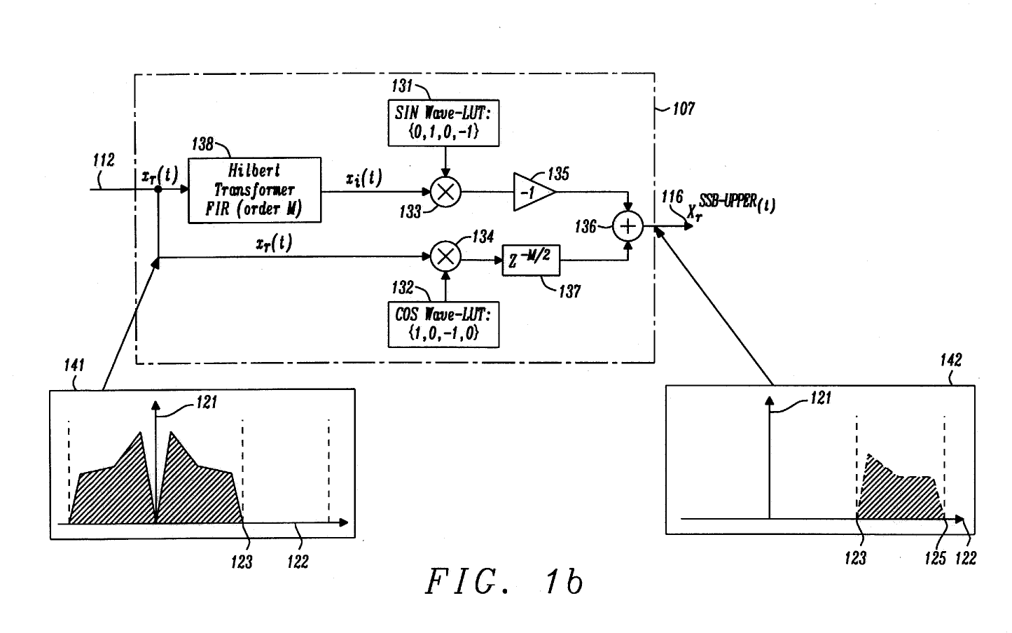

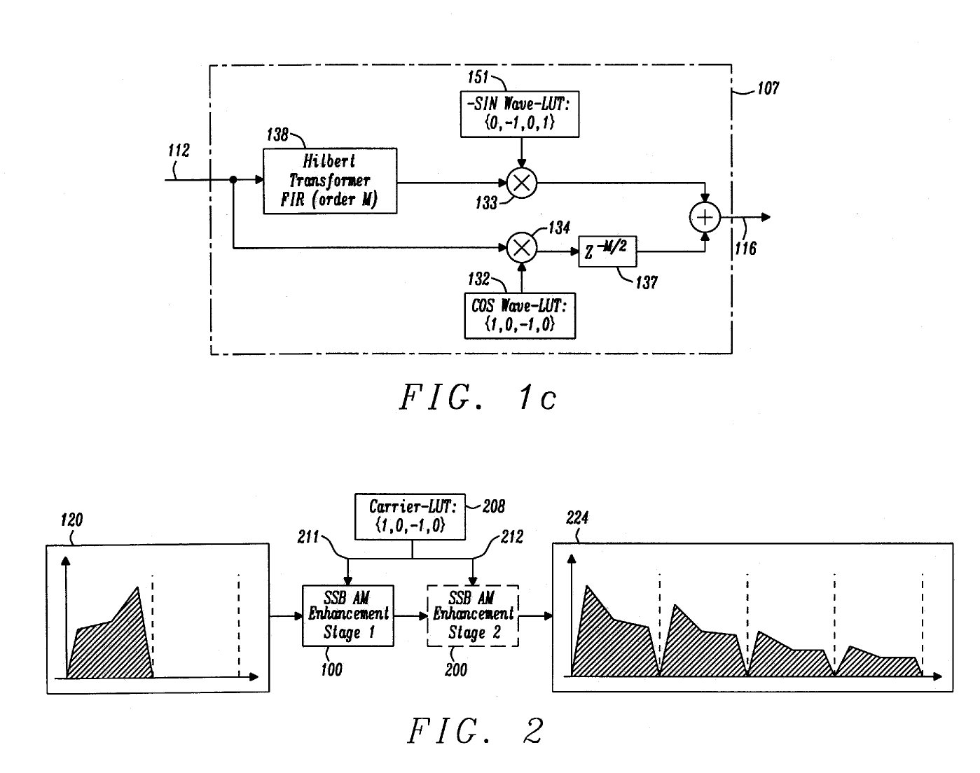

FIG. 1a illustrates a block diagram of an example audio processing unit 100 which is configured to add spectral content to an input audio signal 111, in order to enhance the listening experience of the audio signal 111. In the following the audio processing unit 100 is explained for the case of an input audio signal 111 which is sampled at 8 kHz. It should be noted that the audio processing unit 100 may be applied to arbitrary sampling rates Fₛ.

The input audio signal 111 exhibits a frequency response 120. The frequency response 120 shows the magnitude 121 of the input audio signal 111 for different frequencies 122. It can be seen that the bandwidth of the input audio signal 111 is limited to the frequency range [0 Hz, Fₛ/2], with Fₛ being e.g. 8 kHz. The upper limit of the frequency range of the input audio signal 111 may be referred to as the first frequency 123.

The audio processing unit 100 comprises an upsampling and interpolation unit 101 which is configured to generate an upsampled audio signal 112 from the input audio signal 111. In the illustrated example, the upsampling and interpolation unit 101 comprises an upsampler 102 (which performs e.g. an upsampling by a factor 2), and an interpolation filter 103 (which may be implemented as a Finite Impulse Response (FIR) filter comprising a pre-determined number N of filter coefficients). As a result of the upsampling and interpolation operations, an upsampled audio signal 112 is obtained which is sampled at the increased second sampling rate, e.g. at two times the first sampling rate i.e. 2×Fₛ.

The audio processing unit 100 comprises a delay unit 104 which is configured to delay the upsampled audio signal 112 by a pre-determined delay, e.g. a pre-determined number of samples. Typically, the delay corresponds to the processing delay which is incurred by the upsampled audio signal 112 when being processed by a parallel modulation unit 107. Hence, the delay unit 104 ensures that the delayed audio signal 114 reaches a combining unit 106 in synchronicity with a modulated audio signal 113 (at the output of the modulation unit 107), such that corresponding samples of the delayed audio signal 114 and of the modulated audio signal 113 can be added.

The audio processing unit 100 further comprises a modulation unit 107 which is configured to generate a modulated audio signal 116, which comprises a frequency response that is shifted from the baseband (i.e. from the range of [0, Fₛ/2]) to an increased frequency range, e.g. the range [Fₛ/2, Fₛ], wherein Fₛ refers to the first sampling rate. The modulated audio signal 116 may be submitted to a configurable gain unit 105 which is configured to amplify or to attenuate the modulated audio signal 116, to yield the amplified or attenuated modulated audio signal 113. The modulated audio signal 113 and the delayed audio signal 114 are combined in the adding unit 106 (also referred to as the combining unit) to yield the enhanced audio signal 115.

As illustrated in FIG. 1a, the enhanced audio signal 115 exhibits a frequency response 124, wherein the frequency response 124 comprises a power modified (e.g. an amplified or attenuated) copy of the spectrum of the input audio signal 120 within the frequency range, which is bounded by the first frequency 123 and by the second frequency 125. The first frequency 123 may correspond to the Nyquist frequency Fₛ/2 for the first sampling rate Fₛ, and the second frequency 125 may correspond to the Nyquist frequency Fₛ for the second sampling rate 2×Fₛ.

The modulation unit 107 may be configured to generate the modulated audio signal 116 in a computationally efficient manner. In particular, the modulation unit 107 may make use of a carrier frequency which is equal to ¼ of the second sampling frequency, i.e. to Fₛ/2. By doing this, the carrier signal may be described using a carrier look-up table 108 which comprises only the values −1, 0, and +1. As a consequence, a modulation with the carrier signal may be performed by setting to zero a sample of the signal which is to be modulated, by copying a sample of the signal which is to be modulated or by sign inverting a sample of the signal which is to be modulated. Hence, the modulation can be performed in a computationally efficient manner, without requiring any multiplications.

In other words, the audio processing unit 100 may perform the following steps. An input audio signal 111, which may be sampled at Fₛ=8 kHz and which may comprise spectral content up to the first frequency 123 of Fₛ/2=4 kHz, may be received. The input audio signal 111 is upsampled and interpolated by a factor of 2. This may be achieved through zero padding (first sample, 0, second sample, 0, . . . ) and FIR low pass filtering for removing the aliases. At this stage the upsampled audio signal 112 is at a double sampling frequency (e.g. 16 kHz). The upsampled audio signal typically does not comprise any spectral content for frequencies above 4 kHz.

Then the upsampled audio signal 112 undergoes two discrete processes in parallel. Firstly, modulation (e.g. SSB AM) with a carrier frequency of 4 kHz is performed on the upsampled audio signal 112, thereby providing a modulated audio signal 116 with shifted spectral content. The shifted spectral content may be obtained from the input audio signal's upper sideband centered at 4 kHz. As will be outlined in further detail below, the lower sideband content may be cancelled by a Hilbert transformer filter utilized by the modulator unit 107. On the other hand, the upper sideband may be maintained. At the output of the modulator unit 107 a variable gain unit 105 may be used to configure (usually reduce) the power of the resulting upper sideband copy of the spectrum. The gain of the gain unit 105 may be adjusted according to the spectral power which is needed within the region that is filled with spectral content. Secondly, a respective delay buffer 104 is applied to the upsampled audio signal 112. The delay may be equal to the delay which incurred by the modulated audio signal 113 on the modulation processing path.

Subsequently, both paths are summed by the adding unit 106, forming the enhanced audio signal 115, which comprises a doubled spectral content and a doubled sampling frequency. The spectral content of the enhanced audio signal 115 comprises the original content (from the delayed audio signal 114) along with the shifted and power altered (usually power reduced) content (from the modulated audio signal 113).

As indicated above, the modulation unit 107 may be configured to determine the modulated audio signal 116 at a relatively low computational complexity. In particular, the samples of the carrier signal for the SSB AM modulation may be determined in an efficient manner. In the general case, the carrier signal can be adjusted to a frequency of up to ¼ of the second sampling frequency. In the scenario of FIG. 1a, the carrier signal is selected in order to maximize the efficiency of the proposed technique in terms of required memory and cycles. The operating frequency of the modulator is at the second sampling frequency, e.g. 16 kHz. A COS carrier (i.e. a cosine carrier) at ¼ of this second sampling frequency may be used (e.g. at 4 kHz) which yields to a constant sequence of four discrete and fixed samples {1, 0, −1, 0}. This sequence of samples can be stored in a look-up table, thereby eliminating the need for real time calculations of the samples of the carrier signal. From the above samples of the COS carrier, a SIN carrier (i.e. a sine carrier) can also be derived by left shifting the above mentioned samples of the COS carrier by one sample. As a result, the carrier modulation which is implemented as a real time multiplication of the carrier samples with respective signal samples, can be implemented as a passthrough, a sign inverter or a zeroing mechanism of the processed signal values.

FIG. 1b shows a block diagram of an example modulation unit 107. The upsampled audio signal 112 is modulated using the COS carrier. For this purpose, the multiplication unit 134 may apply the samples of the COS carrier, which may be stored in a COS carrier look-up table 132, to samples of the upsampled audio signal 112. The cosine modulated signal may be delayed by a delay unit 137, in order to time align the cosine modulated signal with the sine modulated signal. The sine modulated signal may be determined by applying a Hilbert transformer 138 to the upsampled audio signal 112 and by modulating the Hilbert transformed signal. For this purpose, the multiplication unit 133 may apply the samples of the SIN carrier, which may be stored in a SIN carrier look-up table 131, to the Hilbert transformed signal. The sine modulated signal may be inverted using an inversion unit 135. By adding the delayed cosine modulated signal and the inverted sine modulated signal in the adding unit 136, the modulated audio signal 116 is obtained. FIG. 1b shows the frequency response 141 of the upsampled audio signal 112 and the frequency response 142 of the modulated audio signal 116.

FIG. 1c shows a block diagram of another example modulation unit 107. In the modulation unit 107 of FIG. 1c, the Hilbert transformed audio signal is directly submitted to an inverse SIN carrier (the samples of which may be stored in an inverse SIN carrier look-up table (LUT) 151), thereby removing the need for an inversion unit 135.

The Hilbert transform may be implemented by an FIR filter of a pre-determined order M. The delay unit 137 may be configured to apply a delay which corresponds to M/2 samples.

In mathematical terms, the spectrum Xᵣ^{SSB-UPPER}(e^{jω}) of the modulated signal 116 may be determined as Xᵣ^{SSB-UPPER}(e^{jω})=(X_{c})(e^{jω})+X_{c}*(e^{-jω}))/2, wherein X_{c}(e^{jω}) is the spectrum of the analytical signal x_{c}(t)=xᵣ(t)+xᵢ(t), wherein xᵣ(t) is the time domain upsampled audio signal 112, and wherein xᵢ(t) is the time domain Hilbert transformed audio signal. From the above, the time domain modulated signal 116 may be derived as Xᵣ^{SSB-UPPER}(t)=xᵣ(t)cos(ωt)−xᵢ(t)sin(ωt), which corresponds to the processing performed by the modulation unit 107 of FIGS. 1b and 1c. As such, the processing of the modulation unit 107 may be performed in the time domain.

Enhanced audio signals 115 with further extended bandwidth may be determined by cascading a plurality of audio processing units. This is illustrated in FIG. 2, where a cascaded system comprising a first audio processing unit 100 and a second audio processing unit 200 is shown. The first and second audio processing units may be identical and/or may correspond to the audio processing unit 100 described in the context of FIGS. 1a, 1b, and 1c.

In order to generate an enhanced signal which is sampled at 2^{K} times the first sampling frequency Fₛ of the input audio signal 111 at the input of the first audio processing unit 100, a cascade of K audio processing units may be used. If the input audio signal 111 is sampled at Fₛ=8 kHz, the enhanced audio signal is then at 2^{K}·8 kHz (i.e. K=1, Fₛ=8 kHz→Output Frequency=16 kHz/K=2, Fₛ=8 kHz→Output Frequency=32 kHz). The enhanced audio signal also has an enhanced spectral content 224 which has been derived by several copies of the original upper sideband spectral content of the input audio signal 111.

The carrier signals 211, 212 which are used for the two processing units 100, 200 may be derived based on the same LUT 208 comprising the 4 predefined samples {1, 0, −1, 0}. In relation to the operating/sampling frequency of a particular processing stage 100, 200, the carrier frequency of the respective carrier signals 211, 212 may be as follows:
First processing stage 100: 4 kHz carrier frequency sampled at 16 kHz (16 kHz/4 kHz=4 samples);
Second processing stage 200: 8 kHz carrier frequency sampled at 32 kHz (32 kHz/8 kHz=4 samples).

FIG. 2 shows an example of two processing stages 100, 200, where the first stage 100 generates a signal at 16 kHz sampling rate, while the second stage 200 generates a signal of 32 kHz. The frequency response 224 of the enhanced signal comprises several power level modified (e.g. attenuated and/or amplified) copies of the upper sideband of the frequency response 120 of the input audio signal 111. The plurality of processing stages 100, 200 perform the processing described in the context of FIGS. 1a, 1b, 1c. In particular, each of the plurality of processing stages 100, 200 makes use of a carrier signal with a carrier frequency equal to ¼ of the SSB AM modulator operating frequency. As a result of this, the computational complexity of the processing stages 100, 200 is reduced.

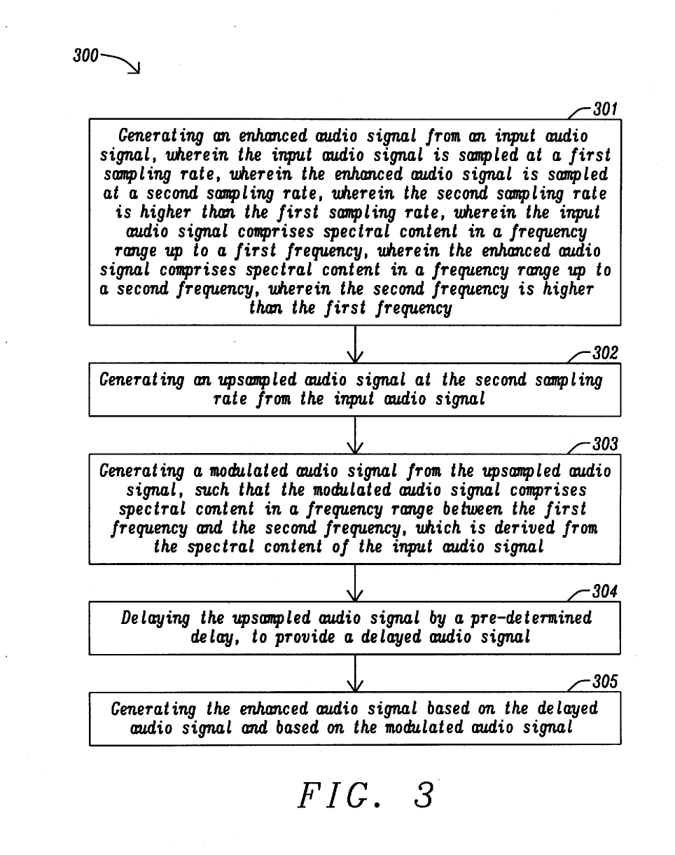

FIG. 3 shows a flow chart of an example method 300 for generating an enhanced audio signal 115 from an input audio signal 111. The method 300 comprises generating 301 an upsampled audio signal 112 at the second sampling rate from the input audio signal 111. Furthermore, the method 300 comprises generating 302 a modulated audio signal 116 from the upsampled audio signal 112, such that the modulated audio signal 116 comprises spectral content in a frequency range between the first frequency 123 and the second frequency 125, which is derived from the spectral content of the input audio signal 111. The modulated audio signal 116 may be power level modified (e.g. attenuated or amplified) using a configurable gain. In addition, the method 300 comprises delaying 303 the upsampled audio signal 112 by a pre-determined delay, to provide a delayed audio signal 114. Furthermore, the method 300 comprises generating 304 the enhanced audio signal 115 based on the delayed audio signal 114 and based on the (possibly power level altered) modulated audio signal 116.

In the present document, a method and a corresponding audio processing unit for enhancing a narrowband audio signal with extended spectral content is described. The enhancement of the narrowband audio signal (sampled e.g. at 8 kHz) may be performed exclusively in the time domain. The enhancement may involve doubling of the output spectral information based on the original spectral information, in order to produce a signal at increased sampling frequency (e.g. at 16 kHz). The enhancement technique can be applied multiple times within a signal processing chain by doubling within each processing stage the spectral information and the sampling frequency (8 kHz→16 kHz→32 kHz, etc.) of the audio signal. The audio processing may be implemented in a computationally efficient manner by using a carrier signal with ¼ of the sampling frequency of the enhanced audio signal. This provides a significant improvement in the memory footprint and cycles, because the samples of the carrier signal may be pre-stored in a look-up-table, eliminating the need for real time calculation of the next carrier sample. Furthermore, the samples of the carrier signal only comprise the values 0, −1, +1, thereby eliminating the need for multiplications.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1) An audio processing unit configured to generate an enhanced audio signal from an input audio signal; wherein the input audio signal is sampled at a first sampling rate; wherein the enhanced audio signal is sampled at a second sampling rate; wherein the second sampling rate is higher than the first sampling rate; wherein the input audio signal comprises spectral content in a frequency range up to a first frequency; wherein the enhanced audio signal comprises spectral content in a frequency range up to a second frequency; wherein the second frequency is higher than the first frequency; wherein the audio processing unit comprises
an upsampling and interpolation unit configured to generate an upsampled audio signal at the second sampling rate from the input audio signal;
a modulation unit configured to generate a modulated audio signal from the upsampled audio signal, such that the modulated audio signal comprises spectral content in a frequency range between the first frequency and the second frequency, which is derived from the spectral content of the input audio signal;
a delay unit configured to delay the upsampled audio signal by a pre-determined delay, to provide a delayed audio signal; and
a combining unit configured to generate the enhanced audio signal based on the delayed audio signal and the modulated audio signal.

2) The audio processing unit of claim 1, wherein
the second sampling rate is two times the first sampling rate;
the second frequency is two times the first frequency; and
the spectral content of the modulated signal is derived from the spectral content of the input audio signal in the frequency range between zero and the first frequency, which has been shifted to the frequency range between the first frequency and the second frequency.

3) The audio processing unit of claim 1, wherein the modulation unit comprises a COS modulator configured to modulate the upsampled audio signal with a sampled cosine carrier signal, to provide a cosine modulated audio signal.

4) The audio processing unit of claim 3, wherein
the cosine carrier signal is sampled at a quarter of the second sampling rate; and
the samples of the sampled cosine carrier signal only comprise one or more of the following values: 0, −1, +1.

5) The audio processing unit of claim 3, wherein the modulation unit comprises
a Hilbert transform unit configured to generate a transformed audio signal from the upsampled audio signal, such that the transformed audio signal comprises spectral content which is phase shifted with respect to the spectral content of the upsampled audio signal; and
a SIN modulator configured to modulate the transformed audio signal with a sampled sine carrier signal, to provide a sine modulated audio signal.

6) The audio processing unit of claim 5, wherein
the sine carrier signal is sampled at a quarter of the second sampling rate; and
the samples of the sampled sine carrier signal only comprise one or more of the following values: 0, −1, +1.

7) The audio processing unit of claim 6, wherein the SIN modulator and/or the COS modulator are configured to generate a sample of a modulated output signal from a sample of an input signal by one or more of the following operations:
setting to zero the sample of the input signal;
copying the sample of the input signal; and/or
sign inverting the sample of the input signal.

8) The audio processing unit of claim 5, wherein
the modulation unit comprises a look-up table comprising the samples of the sampled cosine carrier signal and/or the samples of the sampled sine carrier signal; and
the SIN modulator and/or the COS modulator are configured to access the look-up table for generating the sine and/or cosine modulated audio signals, respectively.

9) The audio processing unit of claim 5, wherein the modulation unit comprises
a second delay unit configured to delay the cosine modulated audio signal by a pre-determined second delay;
a second combination unit configured to generate the modulated audio signal from the delayed cosine modulated audio signal and from the sine modulated audio signal.

10) The audio processing unit of claim 1, wherein the modulation unit is configured to perform single sideband amplitude modulation of the upsampled audio signal using a carrier signal which is sampled at a quarter of the second sampling rate.

11) The audio processing unit of claim 1, wherein
the combination unit is configured to generate a sample of the enhanced audio signal based on corresponding samples of the delayed audio signal and the modulated audio signal; and
the pre-determined delay corresponds to a processing delay incurred within the modulation unit, such that the corresponding samples of the delayed audio signal and the modulated audio signal correspond to the same sample of the upsampled audio signal.

12) The audio processing unit of claim 1, wherein
the audio processing unit comprises a gain unit configured to attenuate the modulated audio signal, to provide an attenuated audio signal; and
the combining unit is configured to generate the enhanced audio signal based on the delayed audio signal and based on the attenuated audio signal.

13) The audio processing unit of claim 1, wherein the upsampling and interpolation unit comprises
an upsampling unit configured to insert one or more zero samples into a sequence of samples of the input audio signal, to provide an intermediate signal; and
an interpolation unit configured to filter the intermediate signal to provide the upsampled audio signal.

14) A system for enhancing an input audio signal with additional spectral content, the system comprising a first audio processing unit, configured to generate a first enhanced audio signal from the input audio signal, and a second audio processing unit, configured to generate a second enhanced audio signal from the first enhanced audio signal, wherein said first audio processing unit and said second audio processing unit audio are configured to generate an enhanced audio signal from an input audio signal; wherein the input audio signal is sampled at a first sampling rate; wherein the enhanced audio signal is sampled at a second sampling rate; wherein the second sampling rate is higher than the first sampling rate; wherein the input audio signal comprises spectral content in a frequency range up to a first frequency; wherein the enhanced audio signal comprises spectral content in a frequency range up to a second frequency; wherein the second frequency is higher than the first frequency; wherein each of said first and second audio processing units comprises
an upsampling and interpolation unit configured to generate an upsampled audio signal at the second sampling rate from the input audio signal;
a modulation unit configured to generate a modulated audio signal from the upsampled audio signal, such that the modulated audio signal comprises spectral content in a frequency range between the first frequency and the second frequency, which is derived from the spectral content of the input audio signal;
a delay unit configured to delay the upsampled audio signal by a pre-determined delay, to provide a delayed audio signal; and
a combining unit configured to generate the enhanced audio signal based on the delayed audio signal and the modulated audio signal.

15) The system of claim 14, wherein
the second sampling rate is two times the first sampling rate;
the second frequency is two times the first frequency; and
the spectral content of the modulated signal is derived from the spectral content of the input audio signal in the frequency range between zero and the first frequency, which has been shifted to the frequency range between the first frequency and the second frequency.

16) The system of claim 14, wherein said modulation unit comprises a COS modulator configured to modulate the upsampled audio signal with a sampled cosine carrier signal, to provide a cosine modulated audio signal.

17) The system of claim 16 wherein
the cosine carrier signal is sampled at a quarter of the second sampling rate; and
the samples of the sampled cosine carrier signal only comprise one or more of the following values: 0, −1, +1.

18) A method for generating an enhanced audio signal from an input audio signal; wherein the input audio signal is sampled at a first sampling rate; wherein the enhanced audio signal is sampled at a second sampling rate; wherein the second sampling rate is higher than the first sampling rate; wherein the input audio signal comprises spectral content in a frequency range up to a first frequency; wherein the enhanced audio signal comprises spectral content in a frequency range up to a second frequency; wherein the second frequency is higher than the first frequency; wherein the method comprises
generating an upsampled audio signal at the second sampling rate from the input audio signal;
generating a modulated audio signal from the upsampled audio signal, such that the modulated audio signal comprises spectral content in a frequency range between the first frequency and the second frequency, which is derived from the spectral content of the input audio signal;
delaying the upsampled audio signal by a pre-determined delay, to provide a delayed audio signal; and
generating the enhanced audio signal based on the delayed audio signal and based on the modulated audio signal.

19) The method of claim 18 wherein said modulated audio signal generated from a modulation unit comprises a COS modulator which modulates the upsampled audio signal with a sampled cosine carrier signal, to provide a cosine modulated audio signal.

20) The method of claim 19, wherein
said cosine carrier signal is sampled at a quarter of said second sampling rate; and
the samples of said sampled cosine carrier signal only comprise one or more of the following values: 0, −1, +1.

21) The method of claim 18, wherein said modulation unit comprises
a Hilbert transform unit generates a transformed audio signal from the upsampled audio signal, such that the transformed audio signal comprises spectral content which is phase shifted with respect to the spectral content of the upsampled audio signal; and
a SIN modulator modulates the transformed audio signal with a sampled sine carrier signal, to provide a sine modulated audio signal.

22) The method of claim 21, wherein
said sine carrier signal is sampled at a quarter of said second sampling rate; and
the samples of the said sampled sine carrier signal only comprise one or more of the following values: 0, −1, +1.
